(19) United States
(12) Patent Application Publication
(10) Pub. No.: US 2025/0147231 A1
(43) Pub. Date: May 8, 2025

(54) OPTICAL ANTENNA

(71) Applicant: SILITH TECHNOLOGY PTE. LTD., SINGAPORE (SG)

(72) Inventors: Guangzhu ZHOU, Shanghai (CN); Shuxin WANG, Shanghai (CN)

(73) Assignee: SILITH TECHNOLOGY PTE. LTD., SINGAPORE (SG)

(21) Appl. No.: 18/923,614

(22) Filed: Oct. 22, 2024

(30) Foreign Application Priority Data
Nov. 2, 2023 (CN) 202311443271.X

(51) Int. Cl. G02B 6/10

(52) U.S. Cl. CPC G02B 6/10

(57) ABSTRACT

Optical antenna includes waveguide; first dielectric structures are arranged outside two sides of waveguide respectively and are symmetrically and periodically arranged in light propagation direction; second dielectric structures are arranged on two sides of upper portion of waveguide respectively and are symmetrically and periodically arranged in light propagation direction; waveguide, first dielectric structures and second dielectric structures are isolated by third dielectric, periodic size of first dielectric structures is consistent with periodic size of second dielectric structures, and first dielectric structures and second dielectric structures have certain relative displacement deviation in light propagation direction; evanescent field around waveguide is disturbed through first dielectric structure and second dielectric structure, so that two correspondingly generated radiation light fields cancel interference below waveguide, and radiation energy is radiated to upper free space side. According to invention, free space side high radiation efficiency and far field high directivity wave beams can be realized.

### CROSS-REFERENCE TO RELATED APPLICATION

This application claims the priority benefit of China application serial no. 202311443271.X, filed on Nov. 2, 2023. The entirety of the above-mentioned patent application is hereby incorporated by reference herein and made a part of this specification.

### BACKGROUND

### Technical Field

The present application relates to the technical field of photonic integrated circuit process, and in particular to an optical antenna having a high-directivity and a high-efficiency applicable to an optical phased array (OPA).

### Description of Related Art

An on-chip integrated optical phased array is an array composed of a series of optical nano-antenna units, which is able to achieve rapid and accurate beam scanning in an electric control manner, having a wide application prospect in a plurality of aspects including optical communication, light detection and ranging (LiDAR), and more.

In the prior art, there are a plurality of important factors limiting a detection distance of the optical phased array, including an on-chip loss, a radiation efficiency of an antenna, and an effective radiation aperture of the array. In a grating antenna designed based on a commercial SOI wafer structure, an absence of a bottom plate leaks nearly half energy to a substrate side, resulting in a waste of the energy. In addition, performing directly an etch to an upper surface or a side wall of a waveguide results in a strong radiation, which has severely limited an effective radiation length (a radiation aperture) of an antenna unit, resulting in a 3 dB beam width of a far-field beam getting relatively large. Both an energy leakage on the substrate side and a limited radiation length of the antenna unit will generate a limitation on a detection range that the optical phased array is able to achieve. Therefore, how to design an antenna unit of the optical phased array, so as to achieve an radiation having a high-directivity and a high-efficiency is a technical problem that needs to be solved currently.

In the prior art, there is an optical antenna, adopting a distributed Bragg reflector (DBR) as the bottom plate to achieve a high-efficiency radiation of the antenna, while adopting a silicon nitride grating arranged on an upper layer of a silicon waveguide to perform a weak disturbance onto a guided wave in the waveguide, so as to achieve a long radiation aperture. However, processing a structure of the DBR in a structure of the optical antenna is complicated, and there is a problem existing that the DBR is incompatible with a CMOS process in the prior art.

Another optical antenna in the prior art, adopts a form of arranging a plurality of dielectric blocks for radiation distributed periodically on both sides of a sub-wavelength grating (SWG) waveguide at a center, and the plurality of dielectric blocks give out a radiation by disturbing an evanescent field, so that a radiation intensity of the antenna is reduced greatly; in addition, by performing a secondary shallow-etching onto the plurality of dielectric blocks, an up-and-down structural asymmetry is increased, thus the radiation efficiency can be improved to over 70%. Although a structure of the optical antenna can achieve a weak radiation rate, thus obtaining the 3 dB beam width of the far-field beam extremely narrow (a high directional beam). However, the radiation efficiency thereof is improved limitedly and a bandwidth is narrow.

Therefore, it is necessary to provide a novel optical antenna having a high-directivity and a high-efficiency, being able to further improve the radiation efficiency of the antenna and prevent the radiation aperture of the antenna from being limited on a basis of being compatible with the CMOS process in the prior art.

### SUMMARY

The purpose of the present application is providing an optical antenna, so as to overcome the above described defects in the prior art.

In order to achieve the aforementioned goals, the technical solution of the present application to solve the technical problems is as follows:
the present application provides an optical antenna, comprising:
a waveguide;
a plurality of first dielectric structures, arranged outside both sides of the waveguide respectively, and arranged periodically and symmetrically along a light propagation direction; and
a plurality of second dielectric structures, arranged on both sides above the waveguide respectively, and arranged periodically and symmetrically along the light propagation direction, wherein the waveguide, the plurality of first dielectric structures and the plurality of second dielectric structures are separated by a third dielectric, a periodic size of the plurality of first dielectric structures is consistent with a periodic size of the plurality of second dielectric structures, and the plurality of first dielectric structures and the plurality of second dielectric structures have a displacement offset relative to each other along the light propagation direction; the plurality of first dielectric structures and the plurality of second dielectric structures disturb an evanescent field around the waveguide, and generate two radiation light fields correspondingly, the two radiation light fields interfere with each other before being cancelled under the waveguide, and a radiation energy is radiated to an upper free space side.

Further, the plurality of first dielectric structures, relative to the plurality of second dielectric structures, have the displacement offset ahead along a propagation direction facing to the light.

Further, a center of each of the plurality of first dielectric structures, relative to a center of each of the plurality of second dielectric structures, has the displacement offset ahead along the propagation direction facing to the light.

Further, the waveguide comprises a strip-shaped waveguide; and/or, each of the plurality of first dielectric structures comprises a first dielectric block, and a shape of the first dielectric block comprises one of a rectangle, a square, a circle, and an ellipse; and/or, each of the plurality of second dielectric structures comprises a second dielectric block, and a shape of the second dielectric block comprises one of a rectangle, a square, a circle, and an ellipse.

Further, a width of the waveguide is greater than a width of each of the plurality of first dielectric structures and a width of each of the plurality of second dielectric structures, a height of the waveguide is greater than a height of each of the plurality of first dielectric structures, while a height of each of the plurality of second dielectric structures is greater than the height of the waveguide; an area of each of the plurality of first dielectric structures is greater than an area of each of the plurality of second dielectric structures; and/or a distance between a side surface of each of the plurality of first dielectric structures and an opposite side surface of the waveguide is greater than a distance between a bottom surface of each of the plurality of second dielectric structures and a top surface of the waveguide; and/or the distance between the side surface of each of the plurality of first dielectric structures and the opposite side surface of the waveguide is less than a distance between two opposite side surfaces of two of the plurality of second dielectric structures arranged symmetrically; and/or the distance between the two opposite side surfaces of the two second dielectric structures arranged symmetrically is less than the width of the waveguide.

Further, the optical antenna is wrapped in a cladding layer formed by the third dielectric, and the cladding layer is arranged on a surface of a substrate.

Further, a material of the waveguide, the plurality of first dielectric structures and the plurality of second dielectric structures comprise any one of silicon, silicon nitride, silicon oxynitride, lithium niobate, indium phosphide, aluminum oxide and a polymer thereof; and/or the third dielectric comprises silicon dioxide; and a refractive index of the material of the waveguide, the plurality of first dielectric structures and the plurality of second dielectric structures is higher than a refractive index of a material of the third dielectric.

Further, the optical antenna is arranged on an SOI substrate, the SOI substrate has a substrate silicon layer, a buried oxide layer and a top silicon layer arranged sequentially, the waveguide and the plurality of first dielectric structures are formed by the top silicon layer, the buried oxide layer forms a lower cladding layer of the optical antenna, the buried oxide layer has an isolation cladding layer arranged on a surface thereof, the isolation cladding layer covers the waveguide and the plurality of first dielectric structures, the plurality of second dielectric structures are formed on a surface of the isolation cladding layer; the isolation cladding layer has an upper cladding layer arranged on a surface thereof, while the upper cladding layer covers the plurality of second dielectric structures and forms a cladding layer to wrap the optical antenna together with the isolation cladding layer and the buried oxide layer which acts as the lower cladding layer.

Further, by controlling a size of the distance between the side surface of each of the plurality of first dielectric structures and the opposite side surface of the waveguide, and controlling a size of the distance between the two opposite side surfaces of the two second dielectric structures arranged symmetrically, a radiation intensity of the optical antenna is controlled; and/or by controlling the size of the distance between the side surface of each of the plurality of first dielectric structures and the opposite side surface of the waveguide, and controlling the width of each of the plurality of second dielectric structures, a radiation rate of the optical antenna is controlled.

Further, the waveguide has a width of 0.5 μm and a height of 0.22 μm; each of the plurality of first dielectric structures has a length of 0.36 μm, a width of 0.2 μm, and a height of 70 nm; each of the plurality of second dielectric structures has a length of 0.3 μm, a width of 0.2 μm, and a height of 330 nm; a distance between the side surface of each of the plurality of first dielectric structures and the opposite side surface of the waveguide is 130 nm; the distance between the opposite side surfaces of two of the plurality of second dielectric structures arranged symmetrically is 400 nm; the distance between the bottom surface of each of the plurality of second dielectric structures and the top surface of the waveguide is 50 nm; the periodic size of the plurality of first dielectric structures and the periodic size of the plurality of second dielectric structures are 720 nm, and the displacement offset relative to each other between the two is 120 nm; the optical antenna has a length of 100 μm.

It can be seen from the technical solution stated above that the present application, by arranging the plurality of first dielectric structures outside both sides of the waveguide and symmetrically along the light propagation direction, and arranging the plurality of second dielectric structures on both sides above the waveguide and symmetrically along the light propagation direction, while arranging the periodic size of the plurality of first dielectric structures to be consistent with the periodic size of the plurality of second dielectric structures, and arranging the plurality of first dielectric structures and the plurality of second dielectric structures to have a certain relative displacement offset along the light propagation direction, the present application is possible to disturb the evanescent field existing around the waveguide through the plurality of first dielectric structures and the plurality of second dielectric structures, so two radiation light fields generated correspondingly are interfering with each other before being cancelled under the waveguide, and the radiation energy is radiated to an upper free space side. The present application performs a radiation by controlling synchronously the plurality of first dielectric structures distributed periodically in a same layer at both sides of the waveguide at center and the plurality of second dielectric structures distributed periodically in a same layer at both sides above the waveguide at center to disturb a guided wave field, achieves a high radiation efficiency at the free space side by using an interference cancellation; and by disturbing the evanescent field of the waveguide at center to form the radiation, achieves a radiation rate controllable, and an effective radiation aperture in any lengths, thereby achieving a far-field high-directivity beam.

### BRIEF DESCRIPTION OF THE DRAWINGS

FIG. 1 illustrates a schematic plan view on an optical antenna according to a preferred embodiment of the present application;

FIG. 2 illustrates a schematic cross section view on an optical antenna according to a preferred embodiment of the present application;

FIG. 3 illustrates a schematic diagram on an electric field distribution during an optical antenna working according to a preferred embodiment of the present application; wherein the horizontal coordinate and the vertical ordinate are corresponding to the X-axis and the Z-axis of a spatial rectangular coordinate system respectively, and a coordinate unit is “μm”.

### DESCRIPTION OF THE EMBODIMENTS

In order to make the purpose, technical solution and advantages of the present application clearer and more explicit, further detailed descriptions of the present application are stated here, referencing to the attached drawings and some embodiments of the present application. Obviously, the described embodiments are part of, but not all of, the embodiments of the present application. Based on the embodiments of the present application, all other embodiments obtained by those of ordinary skills in the art without any creative work are included in the scope of protection of the present application. Unless otherwise defined, technical or scientific terms used herein should have the meanings usually understood by those of ordinary skills in the art to which the present application belongs. As used herein, the terms “comprise” and the like are intended to mean that an element or item appearing before the term encompasses elements or items appearing after the term and the equivalents thereof, instead of excluding other elements or items.

Specific embodiments of the present application are further described in details below with reference to the accompanying drawings.

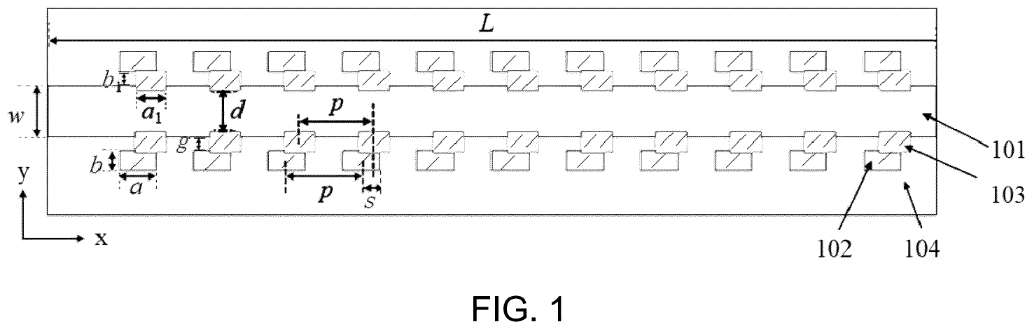

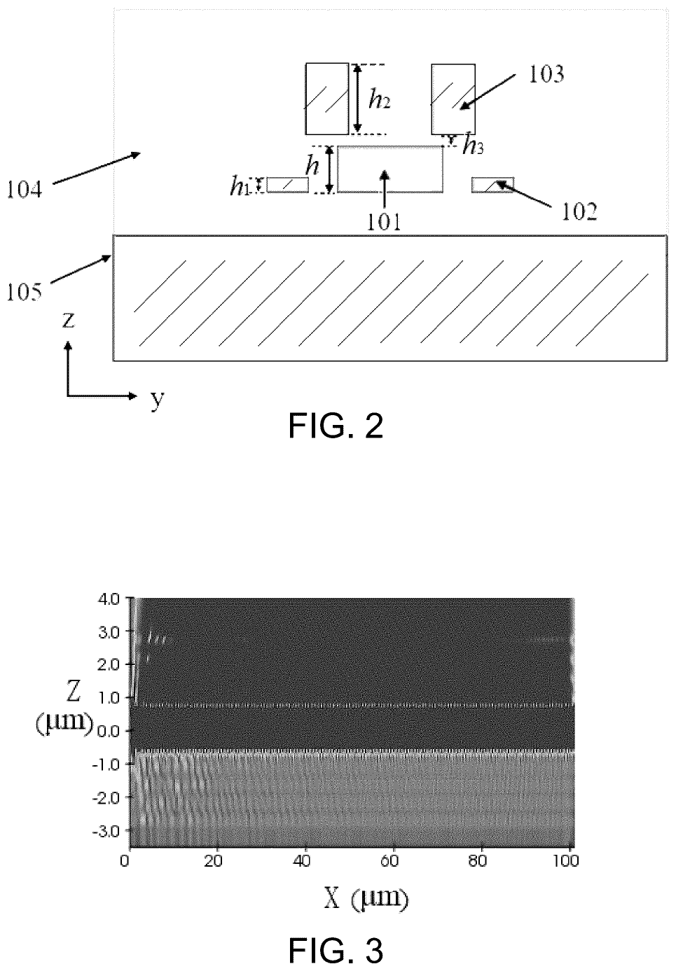

Referring to FIG. 1 and FIG. 2, the present application discloses an optical antenna, comprising a waveguide 101, a plurality of first dielectric structures 102, and a plurality of second dielectric structures 103.

Wherein the waveguide 101 is arranged along a light propagation direction (that is, the waveguide 101 is following an X-axis direction in a spatial rectangular coordinate system shown as FIG. 1). The waveguide 101 has a width W and a height H (the width W of the waveguide 101 is a width W in a Y-axis direction of the spatial rectangular coordinate system shown in FIG. 1, the height H of the waveguide 101 is a height H in a Z-axis direction of the spatial rectangular coordinate system shown in FIG. 2, wherein FIG. 2 and FIG. 1 are established in the same spatial rectangular coordinate system, and FIG. 2 could be regarded as a cross-sectional profile of the optical antenna formed by cutting the waveguide 101 in the Y-axis direction at any one of the plurality of first dielectric structures 102 in FIG. 1).

The plurality of first dielectric structures 102 are arranged in pairs outside both sides of the waveguide 101 along the direction, so as to form a plurality of pairs of the first dielectric structures 102 arranged symmetrically and periodically on both sides of the waveguide 101 along the light propagation direction. There is a distance G, along the Y-axis direction, between a side surface of the plurality of first dielectric structures 102 and an opposite side surface of the waveguide 101.

The plurality of second dielectric structures 103 are also arranged in pairs on both sides above the waveguide 101 to form a plurality of pairs of the second dielectric structures 103 arranged symmetrically and periodically on both sides above the waveguide 101 along the light propagation direction. A number, or a number of pairs, of the plurality of second dielectric structures 103 is corresponding to a number, or a number of pairs of the plurality of first dielectric structures 102, and the plurality of second dielectric structures 103 is arranged separating from the plurality of first dielectric structures 102. A bottom surface of the plurality of second dielectric structures 103 and a top surface of the waveguide 101 have a certain distance H3 (the distance H3 is along the Z-axis of the spatial rectangular coordinate system shown in FIG. 2). Two opposite side surfaces of the plurality of second dielectric structures 103 in each pair of the second dielectric structures 103 are separated by a certain distance D (the distance D is in the Y-axis direction).

The optical antenna has a length L along the light propagation direction; and the length L of the optical antenna may be arranged according to a design requirement. The number of pairs of the plurality of first dielectric structures 102 and the number of pairs of the plurality of second dielectric structures 103 shown in FIG. 1 are merely an example, instead of limiting the number of the plurality of first dielectric structures 102 and the number of the plurality of second dielectric structures 103.

The waveguide 101, the plurality of first dielectric structures 102, and the plurality of second dielectric structures 103 are separated by a third dielectric, that is, a material of a cladding layer 104.

A distance between two centers of every two adjacent first dielectric structures 102 on a same side, or a distance between every two adjacent pairs of the plurality of first dielectric structures 102, forms a periodic size of the plurality of first dielectric structures 102. A distance between two centers of every two adjacent second dielectric structures 102 on a same side, or a distance between every two adjacent pairs of the plurality of second dielectric structures 102, forms a periodic size of the plurality of second dielectric structures 102. The periodic size of the plurality of first dielectric structures 102 is consistent with the periodic size of the plurality of second dielectric structures 103, thus a same period P is adopted herein to indicate that both have the same period size.

Further, the plurality of first dielectric structures 102 and the plurality of second dielectric structures 103 have a displacement offset S relatively to each other along the light propagation direction, that is, each of the plurality of first dielectric structures 102 and each of the plurality of second dielectric structures 103 correspondingly, or each pair of the plurality of first dielectric structures 102 and a corresponding pair of the plurality of second dielectric structures 103, have a certain front and back misalignment along the light propagation direction.

The optical antenna disclosed in the present application, when light is entering the waveguide 101 from a left end of the waveguide 101 and propagating to a right end, shown as FIG. 1, the plurality of first dielectric structures 102 and the plurality of second dielectric structures 103 disturb an evanescent field existing around the waveguide 101, and generate two radiation light fields correspondingly, under the waveguide 101, the two radiation light fields interfere with each other and get cancelled, and the radiation energy will be radiated to the upper free space side, thereby a high radiation efficiency to the free space side is achieved.

Referencing to FIG. 1 and FIG. 2, in a plurality of embodiments, any one of the plurality of first dielectric structures 102 located on a same side has a displacement offset S ahead along a propagation direction facing to the light, relative to one of the plurality of second dielectric structures 103 correspondingly, that is, in a direction facing to a right end of the waveguide 101.

Further, a center of any one of the plurality of first dielectric structures 102 located on the same side has the displacement offset S ahead along the propagation direction facing to the light, relative to a center of one of the plurality of second dielectric structures 103 correspondingly.

In a plurality of embodiments, the waveguide 101 comprises a strip waveguide, shown as FIG. 1, the strip waveguide extends from left to right.

In a plurality of embodiments, each of the plurality of first dielectric structures 102 comprises a first dielectric block; and a planar shape of the first dielectric block along the X-Y plane direction in FIG. 1 comprises a rectangle, a square, a circle, or an ellipse.

Each of the plurality of second dielectric structures 103 comprises a second dielectric block; and a planar shape of the second dielectric block along the X-Y plane direction in FIG. 1 comprises a rectangle, a square, a circle, or an ellipse.

Referencing to FIG. 1 and FIG. 2, in a plurality of embodiments, a width W of the waveguide 101 is greater than a width B of each of the plurality of first dielectric structures 102 and a width B1 of each of the plurality of second dielectric structures 103, a height H of the waveguide 101 is greater than a height H1 of each of the plurality of first dielectric structures 102, and a height H2 of each of the plurality of second dielectric structures 103 is greater than the height H of the waveguide 101.

In a plurality of embodiments, an area of each of the plurality of first dielectric structures 102 is greater than an area of each of the plurality of second dielectric structures 103.

In a plurality of embodiments, a distance G between the side surface of each of the plurality of first dielectric structures 102 and the opposite side surface of the waveguide 101 is greater than the distance H3 between the bottom surface of each of the plurality of second dielectric structures 103 and the top surface of the waveguide 101.

In a plurality of embodiments, the distance G between the side surface of each of the plurality of first dielectric structures 102 and the opposite side surface of the waveguide 101 is less than the distance D between two opposite sides of two second dielectric structures 103 arranged symmetrically in a pair of the plurality of second dielectric structures 103.

In a plurality of embodiments, the distance D between two opposite sides of two second dielectric structures 103 arranged symmetrically in a pair of the plurality of second dielectric structures 103 is less than the width W of the waveguide 101.

By designing a plurality of parameters including the size and the distance of both the plurality of first dielectric structures 102 and the plurality of second dielectric structures 103, a radiation rate of the plurality of first dielectric structures 102 is equivalent to that of the plurality of second dielectric structures 103.

In a plurality of embodiments, the plurality of first dielectric structures 102 and the waveguide 101 are arranged in a same layer, but thicknesses (heights) of the plurality of first dielectric structures 102 and the waveguide 101 are different; and a bottom surface of the plurality of first dielectric structures 102 (a lower surface shown in FIG. 2) is on a same level with a bottom surface of the waveguide 101. The plurality of second dielectric structures 103 is located above the plurality of first dielectric structures 102 and the waveguide 101.

In a plurality of embodiments, the optical antenna is wrapped in a cladding layer 104 formed by a third dielectric, and the cladding layer 104 is arranged on a surface of a substrate 105. A material of the third dielectric of the cladding layer 104 forms a full filling into a gap between any two of the plurality of first dielectric structures 102, a gap between any two of the plurality of second dielectric structures 103, and a gap between the plurality of first dielectric structures 102, the plurality of second dielectric structures 103 and the waveguide 101.

In a plurality of embodiments, a material of the waveguide 101, a material of the plurality of first dielectric structures 102, and a material of the plurality of second dielectric structures 103 comprise any one of silicon, silicon nitride, silicon oxynitride, lithium niobate, indium phosphide, aluminum oxide, and a polymer thereof.

In a plurality of embodiments, a material of the substrate 105 comprises silicon, the third dielectric comprises silicon dioxide, and a refractive index of a material of the plurality of first dielectric structures 102 and the plurality of second dielectric structures 103 is higher than a refractive index of the silicon dioxide in the third dielectric.

In a plurality of embodiments, the optical antenna is arranged on an SOI substrate; the SOI substrate has a substrate silicon layer, a buried oxide layer, and a top silicon layer arranged sequentially. Wherein the substrate silicon layer is applied as the substrate 105 of silicon, the waveguide 101 and the plurality of first dielectric structures 102 are made and formed by a top silicon layer, and the buried oxide layer forms a lower cladding layer of the optical antenna. The buried oxide layer has an isolation cladding layer arranged on a surface, and the isolation cladding layer covers the waveguide 101 and the plurality of first dielectric structures 102, while the plurality of second dielectric structures 103 are formed on a surface of the isolation cladding layer. The isolation cladding layer has an upper cladding layer arranged on a surface, the upper cladding layer covers the plurality of second dielectric structures 103, and forms the cladding layer 104 wrapping the optical antenna together with the isolation cladding layer and the buried oxide layer acting as a lower cladding layer.

In a plurality of embodiments, by controlling and adjusting a size of the distance between the side surface of the plurality of first dielectric structures 102 and the opposite side surface of the waveguide 101, and controlling at a same time a size of the distance D between two opposite side surfaces of the plurality of second dielectric structures 103 arranged symmetrically, a radiation intensity of the optical antenna is controlled.

In a plurality of embodiments, by controlling and adjusting the size of the distance between the side surface of the plurality of first dielectric structures 102 and the opposite side surface of the waveguide 101, and controlling at a same time a size of the width bi of the plurality of second dielectric structures 103, the radiation rate of the optical antenna is controlled.

Referencing to FIG. 1 and FIG. 2, a working principle of the optical antenna disclosed by the present application is that, when light enters the left end of the waveguide 101, which is made of silicon, from the left side as shown in FIG. 1, and propagates to a right end side along a propagation direction of the waveguide 101, that is, along the X-axis direction, the light is first propagated in the waveguide 101 located at a center, due to a weak binding of the plurality of first dielectric structures 102, which may be made of silicon, to an optical field, there will have an evanescent field of a guided wave existing within a certain range around the waveguide 101 for propagation. Then, the plurality of first dielectric structures 102 distributed periodically on both sides of a same layer of the waveguide 101 will disturb the evanescent field, while the light field radiates towards the free space and both sides of the substrate 105. Further, the plurality of second dielectric structures 103, which may be made of silicon nitride, distributed periodically on both sides of an upper layer of the waveguide 101 will also disturb the evanescent field above the waveguide 101 in a same way, thus the light will radiate to the free space and the substrate 105. By designing the displacement deviation S along the direction of the waveguide between the plurality of first dielectric structures 102 distributed periodically and the plurality of second dielectric structures 103 distributed periodically, it is possible to interfere and cancel the radiation field on a side of the substrate 105, so that the energy will be radiated at the free space side. Since the energy is radiated when disturbing the evanescent field, and by controlling values of the parameters G and D state above, it is possible to control the radiation intensity of the optical antenna, and obtain the radiation aperture in any effective length, before finally achieving a high directivity coefficient of a far-field beam of the optical antenna, that is, an extremely narrow 3 dB beam width.

In an embodiment, the waveguide 101 is made of central high-refractive-index silicon, a plurality of first dielectric blocks made of silicon, that is, the plurality of first dielectric structures 102, and a plurality of second dielectric blocks made of silicon nitride, that is, the plurality of second dielectric structures 103, are forming the optical antenna, which is wrapped in the cladding layer 104 made of low-refractive-index silicon dioxide, and the waveguide 101 is working in a TE mode. The width W of the waveguide 101 is 0.5 μm, and the height, that is, a thickness, H is 0.22 μm; each of the plurality of first dielectric blocks has a length A of 0.36 μm, a width B of 0.2 μm, and a height H1 of 70 nm; each of the plurality of second dielectric blocks has a length A of 0.3 μm, a width B of 0.2 μm, and a height H1 of 330 nm; the distance G between the side surface of each of the plurality of first dielectric blocks and the opposite side surface of the waveguide 101 is 130 nm; the distance D between two opposite sides in each two of the plurality of second dielectric blocks arranged symmetrically is 400 nm; the distance H3 between the bottom surface of each of the plurality of second dielectric blocks and the top surface of the waveguide 101 is 50 nm; both sizes of the period P of the plurality of first dielectric blocks and the period P of the plurality of second dielectric blocks are 720 nm, and the relative displacement offset S in between is 120 nm; while the length L of the optical antenna is 100 μm in the present embodiment.

Referring to FIG. 3, which illustrates a schematic diagram on an electric field distribution on a X-Z plane in the space rectangular coordinate system in FIG. 1 and FIG. 2, when an optical antenna is working. It can be seen from the FIG.s that the optical antenna designed is able to achieve a relatively perfect unidirectional radiation characteristic, and the radiation efficiency at the wavelength of 1550 nm is greater than 95% at the free space side. In addition, the radiation along the propagation direction of the waveguide 101 is relatively weak, and almost uniform; the effective radiation aperture of the optical antenna reaches an order of millimeter, thus the width of the far-field 3 dB beam that can be provided is less than 0.1° theoretically.

All above, it can be seen from the technical solution stated above that the present application, by arranging the plurality of first dielectric structures 102, that is, the plurality of first dielectric blocks, outside both sides of the waveguide 101 and symmetrically along the light propagation direction, and arranging the plurality of second dielectric structures 103, that is, the plurality of second dielectric blocks, on both sides above the waveguide 101 and symmetrically along the light propagation direction, while arranging the periodic size of the plurality of first dielectric structures to be consistent with the periodic size of the plurality of second dielectric structures, and arranging the plurality of first dielectric structures and the plurality of second dielectric structures to have a certain relative displacement offset along the light propagation direction, the present application is possible to disturb the evanescent field existing around the waveguide through the plurality of first dielectric structures and the plurality of second dielectric structures, so two radiation light fields generated correspondingly are interfering with each other before being cancelled under the waveguide 101, and the radiation energy is radiated to an upper free space side. The present application performs a radiation by controlling synchronously the plurality of first dielectric structures distributed periodically in a same layer at both sides of the waveguide 101 at center and the plurality of second dielectric structures distributed periodically in a same layer at both sides above the waveguide 101 at center to disturb a guided wave field, and achieves a high radiation efficiency at the free space side by using an interference cancellation; and by disturbing the evanescent field of the waveguide 101 at center to form the radiation, achieves a radiation rate controllable, and an effective radiation aperture in any lengths, thereby achieving a far-field high-directivity beam.

The optical antenna disclosed by the present application may be manufactured by a commercial SOI structure and in a standard tape-out process, thus it is able to simplify the process. The present application further solves effectively a problem in the prior art that the radiation efficiency of an antenna is low and a radiation aperture length is limited, thus being able to be applied as a plurality of basic antenna units in an optical phased array, so as to achieve a long-distance detection.

While the embodiments of the present application have been described in detail above, it will be apparent to those skilled in the art that various modifications and variations can be made to the embodiments. It should be understood, however, that such modifications and variations are within the scope and spirit of the present application as set forth in the claims. Moreover, the present application described herein is capable of other embodiments and of being practiced or of being carried out in various ways.

What is claimed is:

1. An optical antenna, comprising:
a waveguide;
a plurality of first dielectric structures, arranged outside both sides of the waveguide respectively, and arranged periodically and symmetrically along a light propagation direction; and
a plurality of second dielectric structures, arranged on both sides above the waveguide respectively, and arranged periodically and symmetrically along the light propagation direction,
wherein the waveguide, the plurality of first dielectric structures and the plurality of second dielectric structures are separated by a third dielectric, a periodic size of the plurality of first dielectric structures is consistent with a periodic size of the plurality of second dielectric structures, and the plurality of first dielectric structures and the plurality of second dielectric structures have a displacement offset relative to each other along the light propagation direction; the plurality of first dielectric structures and the plurality of second dielectric structures disturb an evanescent field around the waveguide, and generate two radiation light fields correspondingly, the two radiation light fields interfere with each other before being cancelled under the waveguide, and a radiation energy is radiated to an upper free space side.

2. The optical antenna according to claim 1, wherein the plurality of first dielectric structures, relative to the plurality of second dielectric structures, have the displacement offset ahead along a propagation direction facing to the light.

3. The optical antenna according to claim 1, wherein a center of each of the plurality of first dielectric structures, relative to a center of each of the plurality of second dielectric structures, has the displacement offset ahead along a propagation direction facing to the light.

4. The optical antenna according to claim 1, wherein the waveguide comprises a strip-shaped waveguide; and/or, each of the plurality of first dielectric structures comprises a first dielectric block, and a shape of the first dielectric block comprises one of a rectangle, a square, a circle, and an ellipse; and/or, each of the plurality of second dielectric structures comprises a second dielectric block, and a shape of the second dielectric block comprises one of a rectangle, a square, a circle, and an ellipse.

5. The optical antenna according to claim 1, wherein a width of the waveguide is greater than a width of each of the plurality of first dielectric structures and a width of each of the plurality of second dielectric structures, a height of the waveguide is greater than a height of each of the plurality of first dielectric structures, while a height of each of the plurality of second dielectric structures is greater than the height of the waveguide; an area of each of the plurality of first dielectric structures is greater than an area of each of the plurality of second dielectric structures; and/or a distance between a side surface of each of the plurality of first dielectric structures and an opposite side surface of the waveguide is greater than a distance between a bottom surface of each of the plurality of second dielectric structures and a top surface of the waveguide; and/or the distance between the side surface of each of the plurality of first dielectric structures and the opposite side surface of the waveguide is less than a distance between two opposite side surfaces of two of the plurality of second dielectric structures arranged symmetrically; and/or the distance between the two opposite side surfaces of the two second dielectric structures arranged symmetrically is less than the width of the waveguide.

6. The optical antenna according to claim 5, wherein a radiation intensity of the optical antenna is controlled by controlling a size of the distance between the side surface of each of the plurality of first dielectric structures and the opposite side surface of the waveguide, and controlling a size of the distance between the two opposite side surfaces of the two second dielectric structures arranged symmetrically; and/or a radiation rate of the optical antenna is controlled by controlling the size of the distance between the side surface of each of the plurality of first dielectric structures and the opposite side surface of the waveguide, and controlling the width of each of the plurality of second dielectric structures.

7. The optical antenna according to claim 1, wherein the optical antenna is wrapped in a cladding layer formed by the third dielectric, and the cladding layer is arranged on a surface of a substrate.

8. The optical antenna according to claim 1, wherein a material of the waveguide, the plurality of first dielectric structures and the plurality of second dielectric structures comprise any one of silicon, silicon nitride, silicon oxynitride, lithium niobate, indium phosphide, aluminum oxide and a polymer thereof; and/or the third dielectric comprises silicon dioxide; and a refractive index of the material of the waveguide, the plurality of first dielectric structures and the plurality of second dielectric structures is higher than a refractive index of a material of the third dielectric.

9. The optical antenna according to claim 1, wherein the optical antenna is arranged on an SOI substrate, the SOI substrate has a substrate silicon layer, a buried oxide layer and a top silicon layer arranged sequentially, the waveguide and the plurality of first dielectric structures are formed by the top silicon layer, the buried oxide layer forms a lower cladding layer of the optical antenna, the buried oxide layer has an isolation cladding layer arranged on a surface thereof, the isolation cladding layer covers the waveguide and the plurality of first dielectric structures, the plurality of second dielectric structures are formed on a surface of the isolation cladding layer; the isolation cladding layer has an upper cladding layer arranged on a surface thereof, while the upper cladding layer covers the plurality of second dielectric structures and forms a cladding layer to wrap the optical antenna together with the isolation cladding layer and the buried oxide layer which acts as the lower cladding layer.

10. The optical antenna according to claim 1, wherein the waveguide has a width of 0.5 μm and a height of 0.22 μm; each of the plurality of first dielectric structures has a length of 0.36 μm, a width of 0.2 μm, and a height of 70 nm; each of the plurality of second dielectric structures has a length of 0.3 μm, a width of 0.2 μm, and a height of 330 nm; a distance between the side surface of each of the plurality of first dielectric structures and the opposite side surface of the waveguide is 130 nm; a distance between the opposite side surfaces of two of the plurality of second dielectric structures arranged symmetrically is 400 nm; a distance between the bottom surface of each of the plurality of second dielectric structures and the top surface of the waveguide is 50 nm; the periodic sizes of the plurality of first dielectric structures and the plurality of second dielectric structures are 720 nm, and the displacement offset relative to each other between the two is 120 nm; the optical antenna has a length of 100 μm.
